(19) United States
(12) Patent Application Publication
(10) Pub. No.: US 2002/0144467 A1
(43) Pub. Date: Oct. 10, 2002

(54) Supervision of door and gate edge sensors

(76) Inventor: Rudor M. Teich, West Orange, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/093,257

(22) Filed: Mar. 7, 2002

Related U.S. Application Data
(60) Provisional application No. 60/274,965, filed on Mar. 12, 2001.

(51) Int. Cl. E06B 3/00

(52) U.S. Cl. 49/506

(57) ABSTRACT

A method for monitoring the operation of a mechanical safety switch in a moving barrier. A typical application is the verification that the edge sensor of a garage door correctly senses an obstruction. A trouble indication is generated if the sensor switch does not operate when the door has reached its fully closed position, at which point the safety switch should be engaged by the floor against which the door presses. In those systems in which a signal representative of the door position is not available, a trouble indication is generated if the sensor switch does not operate at least once during a predetermined number of door close activations.

This application claims the benefit of U.S. provisional application No. 60/274,965 filed on Mar. 12, 2001 titled “Door Edge Sensor Monitoring”.

### BACKGROUND OF THE INVENTION

This invention relates to entrapment sensing for moving barriers. The term entrapment refers to the exertion of an undesirable force on an individual by a moving barrier such as, for example, a garage door or gate. Although the disclosure is in terms of a garage door and a garage door opener (GDO), the invention is generally applicable to any kind of moving barrier and moving barrier controller.

A GDO uses a motor to open and close the garage door. The danger of hurting people as the door closes or opens is well documented. The addition of anti-entrapment safety provisions to a GDO is practically a standard feature on any new GDO installation.

One of the oldest and most effective entrapment protection devices is a mechanical or pneumatic safety switch that is mounted at the leading edge of the moving barrier. U.S. Pat. No. 5,412,297 provides an illustration of a popular mechanical switch specifically designed for this purpose. If the barrier encounters an obstacle, the switch will be pressed and will close its circuit. A signal indicative of the closure is sent to the motor controller that operates the barrier, and the motor stops and reverses the barrier to remove the force on the obstacle. This switch arrangement is referred to as an edge sensor. (Throughout this description a switch under pressure is said to close. Obviously, the principles of the invention apply equally to switches that open under pressure.)

Like all mechanisms, especially devices that move constantly, the edge sensor may fail in a number of ways. One failure mode is through the breakage or shorting of the wires leading to the switch. The wires inside the edge sensor are particularly vulnerable due to the repeated pounding the edge sensor is subjected to with every closing of the barrier, as the edge sensor absorbs the impact of the barrier hitting its stationary end. In the case of a garage door, for example, the door comes to rest against the floor, usually with enough force to make sure that a rubber gasket at the bottom is compressed to provide a weather seal.

U.S. Pat. No. 5,262,603 teaches a method for supervising the internal wiring inside an edge sensor. An extra pair of tamper wires is run from the GDO motor to the switch. The switch assembly is thus wired to the GDO by a total of four wires. For example, if the consecutive wire terminations at the edge sensor are labeled 14, the switch may be connected between wires 2 and 3. Wires 1 and 2 may be connected together at one end of the edge sensor, and wires 3 and 4 may be connected together at the other end. Circuitry in the GDO monitors the continuity between the two pairs of wires. Should there be a discontinuity between either of the two pairs, the GDO is programmed to refuse to close the barrier.

A second mode of failure may occur through the internal failure of the switch to operate when subjected to the specified force. The switch can jam open or closed. This mode of failure is not uncommon, especially in sub-freezing temperatures when moisture collected in the edge sensor freezes and impedes the motion of the switch or the sheathing that encapsulates it. U.S. Pat. No. 4,972,054 discloses a way to obtain enhanced reliability against the failure of an internal switch by having two separate switches incorporated in one edge sensor housing. Either switch can cause a barrier reversal in the GDO.

While this solution addresses an internal failure of one of the two internal switches, it falls short of guaranteeing proper operation of the sensor in the event that the entire unit freezes, or if the second switch fails some time after the first switch has failed, as no warning is issued after an internal switch fails.

U.S. Pat. No. 4,908,483 teaches the use of a pneumatic tube together with a pressure switch to sense the force along the tube. This method has the advantage that it eliminates the long electrically-conductive surface of the usual electrical edge sensor, and is thus less sensitive to corrosion and moisture. Unfortunately, the pneumatic edge sensor suffers from the same vulnerability to internal failure as the electric types. The hose that connects the sensing edge tube to the pneumatic switch can become severed or punctured. The pneumatic-electrical switch can also suffer a mechanical failure, and the wires between the switch and the GDO are similarly vulnerable to open circuits and shorts.

It is an object of this invention to overcome the disadvantages of the prior art by providing a way to detect a failure of the sensing operation itself, whether mechanical or pneumatic. The supervision provided by the invention is of benefit to any edge sensor system, even those that supervise the wiring to the sensor, as these do not assure that the sensor itself will respond to a mechanical force against it.

### SUMMARY OF THE INVENTION

The invention is predicated on the idea that one way to verify that an edge sensor is operating properly is to apply a force along its surface and to observe its response. A garage door opener is usually adjusted so that the door rests solidly against the floor when the door is closed. This is done to seal the garage from rodents and from draft, as well as to apply a positive locking force against the door to make a forced entry more difficult. (Similarly, a gate may rest against a post, etc.) While an edge sensor is installed at the leading edge of the door so that it will be disposed between the door and an object being protected from entrapment, I make use of the closure force during normal closing, when the door is against an immoveable surface such as a floor, to detect and confirm proper operation of the edge sensor. When the door closes fully, the controller of the GDO expects a signal from the edge sensor that it is pressing against the floor. The lack of such a signal is taken as an indication that the edge sensor, or the wiring to it, is not working properly.

The proper operation of my method depends on the ability of the GDO controller to know when the door is fully closed, i.e., when the switch of the edge sensor should be in a closed state if it is working properly. In many installations, however, an add-on device is wired to the GDO to add certain features to the system that are not provided by the GDO itself. If the edge sensor supervision is a feature of the add-on device, the add-on may not know when the door is supposed to be fully closed (in which case the device does not know when the switch should be closed in the absence of an obstruction). An example of such an add-on is a receiver that is added to a GDO that does not originally come with an internal radio receiver and thus, without the add-on, cannot be remotely controlled. The addition of a receiver adds the convenience of remote control, or even the ability to use a wireless edge sensor. A system with such capabilities is described in U.S. Pat. No. 5,625,980. In the case of such an add-on system where the edge sensor reports through an RF signal to the receiver, the receiver does not know where the door is at any time, and thus cannot correlate the door position with an obstruction signal (switch closed when door is not fully closed), or the lack of an obstruction signal (switch closed when door is fully closed and pressing against the floor).

To overcome this problem, my invention also provides for a counter that is incremented with each door close command. (These commands are received by the external receiver that activates the GDO to start the door closing.) While each door close command does not guarantee that the door will run to its closed limit (the door may be stopped by the user before reaching the closed limit), it is a reasonable assumption that, during normal operation, the door will be allowed to close to its limit at least once for every few close commands that are issued. The controller reports a trouble with the edge sensor if it does not see at least one edge closure within the time that three close commands are issued.

This aspect of the invention is advantageous in those systems in which a signal representative of the door position is not available. In such a system, the general rule of my invention is that operation of a mechanical safety switch in the moving barrier is monitored by determining whether at least one switch closure occurs during a predetermined number of barrier close activations.

### BRIEF DESCRIPTION OF THE DRAWINGS

Further objects, features and advantages of the invention will become apparent upon consideration of the following detailed description in conjunction with the drawing, in which:

FIG. 1 shows a first illustrative embodiment of the invention, with a GDO controller wired to an edge sensor;

FIG. 2 shows a second illustrative embodiment of the invention, with a GDO controller having an integral RF receiver and a wireless edge sensor;

FIG. 3 is a flow chart of the entrapment supervision logic of the invention as applied to the systems of FIGS. 1 and 2;

FIG. 4 shows a third illustrative embodiment of the invention, with a GDO having an add-on external receiver and a wired edge sensor;

FIG. 5 shows a fourth illustrative embodiment of the invention, with a GDO having an add-on external receiver and a wireless edge sensor; and

FIG. 6 is a flow chart of the entrapment supervision logic of the invention as applied to the systems of FIGS. 4 and 5.

### DETAILED DESCRIPTION OF THE PREFERRED EMBODIMENTS

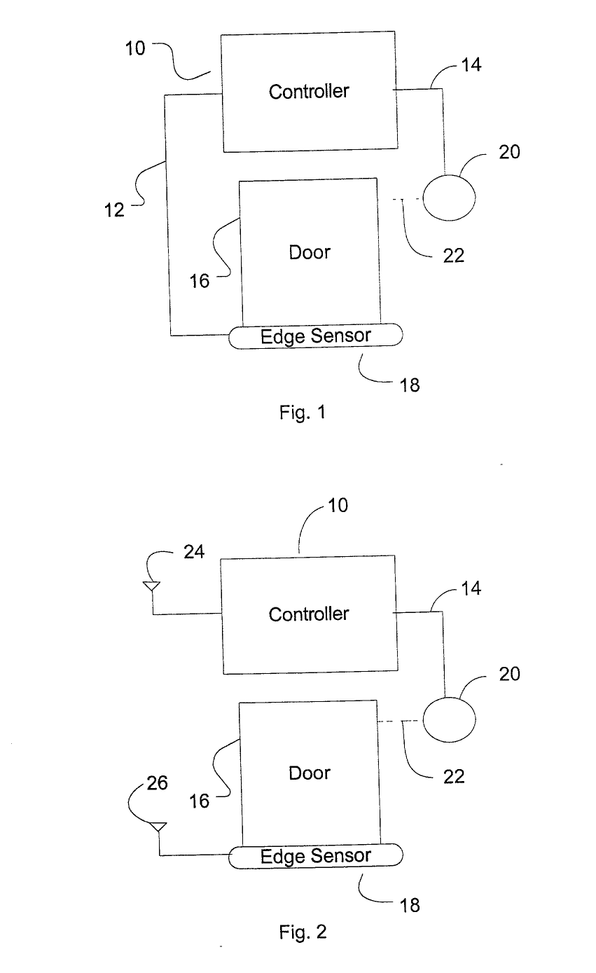

Referring to FIG. 1, a GDO controller 10 controls motor 20 over conductor 14 to control the position of door 16. An edge sensor 18 is wired to the controller 10 through wiring 12. A pressure on edge sensor 18 causes the GDO to reverse the direction of the door movement unless the door has already reached its fully closed limit.

The controller monitors the input from the edge sensor as the door is closing. If the door reaches the full-closed limit and the edge sensor has not reported a closed condition (i.e., that its switch has been depressed), the controller interprets this failure as a problem with the edge sensor or its wiring. The controller then enters into a fault condition. Such a fault condition may take the form of opening the door completely, to prevent injury from entrapment.

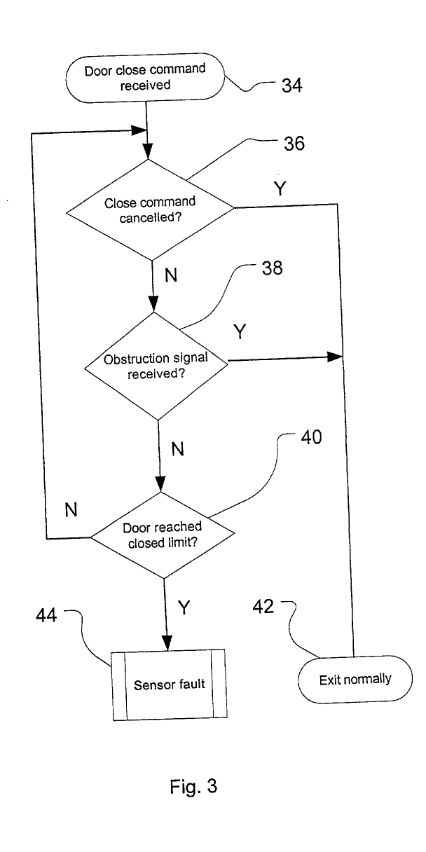

FIG. 3 shows a simplified logic diagram of the edge-sensor fault detection. The routine is entered at point 34 when the GDO receives a command to close the door. If the close command is cancelled in step 36 (by a stop command or and open command), the routine is terminated as shown in step 42. The close state can be cancelled by a wireless remote command from a portable transmitter, or it can be issued by a switch that is wired to the GDO.

While closing, if an obstruction signal is received, the routine is terminated in step 42 without issuing a fault condition. Decision box 38 keeps the routine active as long as the closed limit has not been reached by the door.

If the door reaches the closed limit without having generated an obstruction signal from the edge sensor, it is an indication that there is a sensor fault as indicated by step 44. This condition activates an appropriate response by the GDO. Such a response can take the form of an audible alarm, flashing of lights controlled by the GDO, opening the door part way or fully, or a combination of these and similar actions.

FIG. 2 depicts a GDO with a wireless edge sensor. When the edge sensor switch closes, a signal is sent from antenna 26 to antenna 24. An appropriate transmitter (not shown) is connected to the edge sensor to effect the transmission. The fault detection of the wireless edge sensor is identical to the case of the wired edge sensor described above, and is covered by the logic flow diagram of FIG. 3.

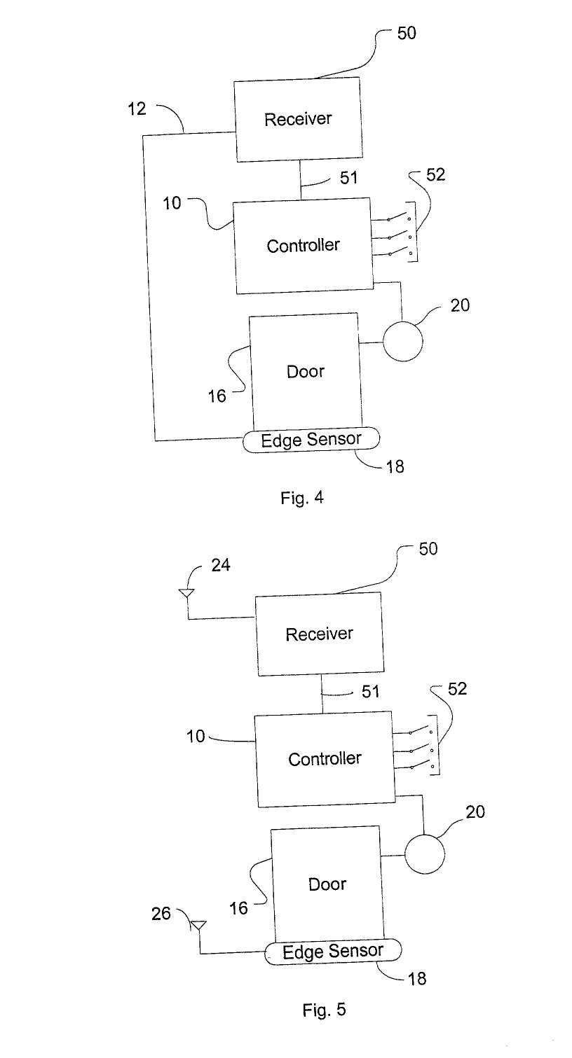

FIG. 4 shows a GDO with an external receiver 50. The system includes a controller 10, a motor 20, a door 16 and an edge sensor 18. The GDO controls the door position as instructed by manual switches 52. These manual switches may be dedicated to generate commands for open, close and stop, or they may be combined into one switch that provides the three commands with consecutive activations of the single switch. These methods of controlling a GDO are well known in the art.

An external, typically add-on, radio receiver 50 is connected to the controller over cable 51 to allow the receiver to control the operation of the controller. The cable also carries back to the receiver information about the switches 52, so that the receiver will be apprised of activation of any of the switches.

The edge sensor 18 is wired to the receiver, rather than to the controller. The reason is that the controller may not support the sensor monitoring that is the subject of this invention, while the add-on receiver described herein does offer this monitoring. If the controller is provided with the monitoring functionality, it falls under the description of FIG. 1.

The system of FIG. 5 is the same as that of FIG. 4, except that antennas 24 and 26 and an associated transmitter connected to the edge sensor inform the receiver of a switch closing in the edge sensor.

While the add-on receiver of FIGS. 4 and 5 monitors the state of the input switches 52 to the GDO which are physically external to the GDO, it is not practical to have the receiver also monitor the position of the internal door travel limit switches (open limit and closed limit), as this requires modifying the wiring of the GDO. For this reason, the receiver edge sensor flow chart needs to be modified from that of FIG. 3.

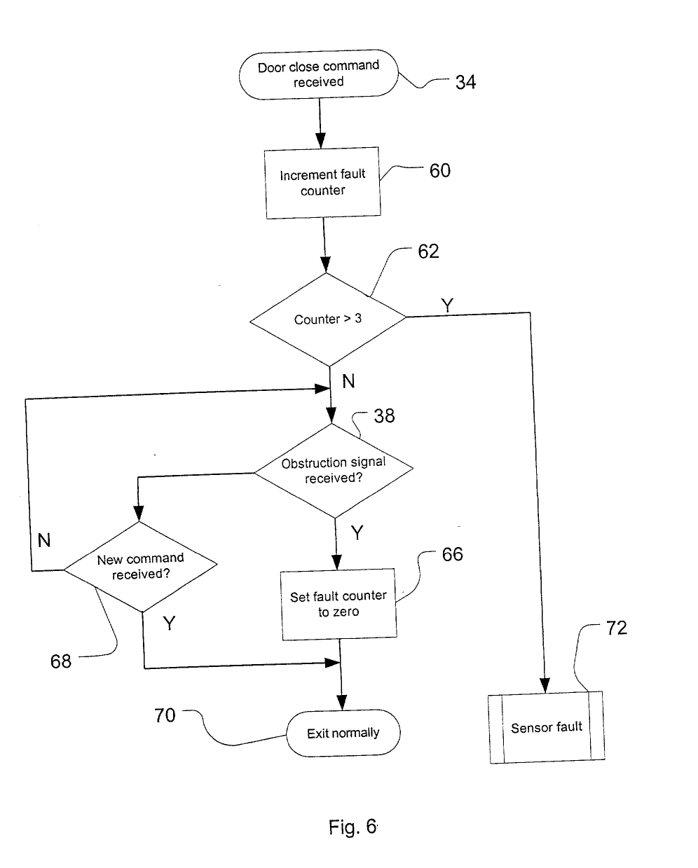

FIG. 6 shows a logic flow diagram for the external receiver of FIGS. 4 and 5. The fault monitoring routine is started at point 34 when a close command is detected by the receiver. This command can come from a remote device via a radio command, or from the switches 52. Once the routine is entered, a fault counter is incremented in step 60, and then tested in decision box 62. If the counter is found to exceed a preset level (3 in the example shown), the receiver determines that a sensor fault condition is present and executes a sensor fault routine in step 72. This routine causes the receiver to provide a visual and audible feedback to the user that the sensor is malfunctioning.

If the counter in step 62 is 3 or less, the routine starts a loop to await an obstruction signal. The loop is routed through decision boxes 38 and 68. The loop will be exited when either an obstruction signal is received from the edge sensor (step 38), or if the close command is replaced with a stop or open command (step 68).

If an obstruction signal is received in step 38, then the fault counter is cleared in step 66 and the routine is exited normally in step 70, without a fault or trouble condition being registered (because a signal was received from the sensor indicating that it is working properly). If the close state is exited by a new command (such as a stop or open command), then the routine is exited without clearing the fault counter. The reason is that the receiver has no way of knowing whether the new command was issued after the door has closed fully (in which case registering a fault would be in order since the door fully closed without the edge sensor having operated), or it was stopped before reaching the floor by the user countermanding the close command. It is expected that at least once in three door close cycles the door will be allowed to travel to its closed limit. By incrementing the fault counter if no edge sensor signal is reported, it can be assumed that the sensor is malfunctioning if a count of 3 is reached.

The logic flow diagram of FIG. 6 applies to the configuration of FIG. 5 as well as that of FIG. 4. However, a failure of the wireless edge RF signal to be received by the receiver in the configuration of FIG. 5 during a close cycle is treated as an obstruction, rather than as a sensor failure, and thus is not covered in the above discussion. The reason is for safety. If a lost signal is treated as sensor trouble, control of what will happen next may be lost because the GDO may be programmed to handle sensor trouble more benignly than an obstruction. As for FIG. 5, in the case of a 2-wire sensor there is no way of knowing that the wire is broken (the equivalent of a blocked RF signal in FIG. 5). Thus the system cannot act on this special case of a broken wire. If the sensor uses 4-wire connection and if the broken wire is one of these 4 wires, not an internal wire, then in the FIG. 4 configuration it is known that there is a sensor trouble.

Although the invention has been described with reference to particular embodiments it is to be understood that these embodiments are merely illustrative of the application of the principles of the invention. Numerous modifications may be made therein and other arrangements may be devised without departing from the spirit and scope of the invention.

What I claim is:

1. A method for monitoring the operation of a mechanical safety switch in a moving barrier by issuing a trouble indication if the switch does not operate when the barrier has reached its fully closed position, at which point the safety switch should be engaged by an immoveable surface against which the barrier presses.

2. A method for monitoring the operation of a mechanical safety switch in a moving barrier in a system in which a signal representative of the barrier position is not available by determining whether at least one switch operation occurs during a predetermined number of barrier close activations.

3. A method for determining that the safety switch in a moving barrier is operative by verifying that the switch operates as expected in response to at least one barrier close activation.

4. A method in accordance with claim 3 wherein a mechanism is provided for controlling movement of the barrier and the mechanism is made aware when the barrier has reached the fully closed position, at which point the switch should be operated.

5. A method in accordance with claim 3 wherein a mechanism is provided for controlling movement of the barrier but the mechanism is not made aware when the barrier has reached the fully closed position other than by operation of the switch, and the switch is determined to be operative by verifying that it operates at least once during a predetermined number of barrier close activations.
